(19) United States
(12) Patent Application Publication
(10) Pub. No.: US 2006/0151958 A1
(43) Pub. Date: Jul. 13, 2006

(54) Packing ring for a turbine

(76) Inventors: Richard Chevrette, Troy, NY (US); Jeyaruban Amirtharajah, Niskayuna, NY (US); David R. Skinner, Pattersonville, NY (US)

Correspondence Address: J. Joseph Muller;Polster, Lieder, Woodruff & Lucchesi, L.C., Suite 200, 12412 Powerscourt Drive, St. Louis, MO, 63131-3615, US

(21) Appl. No.: 11/031,117

(22) Filed: Jan. 7, 2005

(51) Int. Cl. F16J 15/44

(52) U.S. Cl. 277/411

(57) ABSTRACT

A ring segment (100) used to form a packing ring (6). The segment comprises an arcuate shaped piece interfitting with similar pieces to form an effective seal both between adjacent stages of a turbine (1), and an end stage (2) of the turbine and the atmosphere. Each ring segment has a step (14, 15) formed at each end of the segment for interfacing the segment with an adjacent ring segment. The steps are formed on opposite sides of the ring segment and allow adjacent segments to readily interface with each other because an oversize of resulting butt gap (16) is formed between them. This eliminates rework of the segments to assemble the ring, insures a quality seal is affected, and reduces the time the turbine is off-line.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to multi-stage turbine engines; and more particularly, to a packing ring installed between the respective stages of the turbine, and between an end stage of the turbine and the atmosphere, to minimize fluid (steam) leakage from one stage to the next, and to the atmosphere. The packing ring of the invention is especially useful in turbines employed in nuclear power plants where the fluid contains radioactive particles, and fossil fuel based turbines, to minimize maintenance outage time.

In steam turbines the efficiency of the turbine is, in part, affected by the ability to prevent the working fluid from leaking from one stage to the next. For this purpose, one or more packing rings are installed at the interface between stages, and between the outermost stages of the turbine and the atmosphere. The rings provide both a longitudinal seal between stages so the working fluid is properly confined within a stage. The packing ring (or rings) forming the seal comprises a plurality of ring segments (typically 4-12). These are curved or arcuate in shape, and assembled in an end-to-end abutment with one another to form the ring. Each ring segment includes sets of teeth which extend across an inner face of the segment. These teeth interface with the shaft to form a path or labyrinth sufficiently convoluted that leakage from one stage to the next, or to the atmosphere, is minimized. An effective seal is thereby created.

During repair or maintenance of a turbine, the time required to replace packing rings is critical. Typically when a utility shuts down a turbine, it must buy the electricity normally generated by the turbine to service its customers, from another utility. This is expensive. Accordingly, repair work is carefully orchestrated to get the work done in as short a time as possible so the turbine can quickly be brought back on-line.

It will be understood by those skilled in the art that packing rings function in an elevated temperature environment and therefore the ring segments experience thermal expansion and contraction. These effects must be taken into account when the packing ring is assembled so a butt gap, which is created between adjacent ring segments, is sufficiently large to accommodate changes caused by the thermal characteristics. If the gap is too large, then a residual space will remain between segments after they thermally expand, and a leakage path will be created. If the gap is too small, then when the segments expand, they will butt together and expand to a larger diameter thus increasing the redial clearance between the packing and the turbine rotor shaft. Again, an increased leakage path will be created.

Currently, when packing rings are replaced, it is often necessary to rework; i.e., machine individual ring segments so when the rings are assembled and the segments are again exposed to their operating environment, these problems do not occur. It will be appreciated that this rework takes time and can greatly extend the down-time period of the turbine.

Packing rings used in turbines at nuclear power generation facilities pose a special and difficult problem when they need to be replaced because radioactive particles are entrained with the working fluid and, over time, the housing or casing in which the rings are installed becomes radioactive. When the ring segments forming a packing are installed in a casing, they are subjected to this radioactivity. Personnel replacing packing rings must wear appropriate protective clothing to prevent exposure to radiation. If, during ring replacement, the packing ring segments do not properly fit together they must be modified or reworked. However, because of their exposure to radiation, they must first be decontaminated. This takes time and adds to the down-time of the turbine. Further adding to the down-time, is the installer having to repeatedly get out-of and into his protective clothing to work on and then re-assemble the ring segments.

It will be appreciated that an improved ring segment design that would eliminate this cumbersome process, would greatly simplify installation of the ring segments, insure effective operation of the assembled packing ring, and substantially reduce repair and maintenance costs to a utility.

### BRIEF SUMMARY OF THE INVENTION

Briefly stated, the present invention is directed to a ring segment for use in assembling packing rings for a turbine. The segments comprise arcuate shaped pieces interfitting with each other to affect a seal between both adjacent stages of a turbine, and an end stage of the turbine and the atmosphere. Each ring segment has a notch or step formed at each end of the segment, where the segment interfaces with an adjacent segment forming the packing ring. The steps are formed on opposite sides of each adjacent segment in a complimentary manner to form a lap joint seal with a larger butt clearance. An integral feature of the overlap configuration is an oversize butt gap that is created between adjacent ring segments. Now, when the segments thermally expand, there is a gap sufficient for them to expand against each other. However, the butt gap is sized so that the segments will not expand together to a larger diameter when they contact each other, thereby creating a larger leakage path as previously discussed. This ring segment construction provides sufficient thermal expansion capability for operation, simplifies installation of the ring segments, and eliminates the need to rework or modify the segments in order to optimize the sealing capability of an assembled packing ring.

The ring segments of the present invention, by eliminating rework of segments in assembling a packing ring, significantly reduce the time a turbine is off-line and substantially reduces the cost to the utility. In nuclear power plants, the ability to assemble a packing ring the first time has the further advantage of not having to decontaminate the segments for each modification or adjustment, further saving the utility time and money.

The foregoing and other objects, features, and advantages of the invention will be in part apparent and in part pointed out hereinafter.

### BRIEF DESCRIPTION OF THE SEVERAL VIEWS OF THE DRAWINGS

In the accompanying drawings which form part of the specification:

FIG. 1 illustrates a typical end section of a turbine and a packing ring assembly between the end stage of the turbine and the atmosphere;

FIG. 2 is a simplified sectional view of a ring segment tooth construction and the interface between the teeth and a turbine shaft;

FIG. 3 illustrates a packing ring construction using prior art ring segments;

FIGS. 4A illustrates a packing ring construction using ring segments of the present invention, and FIG. 4B the butt gap and overlap between adjacent ring segments;

FIG. 5 is a perspective view of ring segments of the present invention; and,

FIGS. 6-8 illustrate other ring segment constructions illustrating different tooth patterns.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

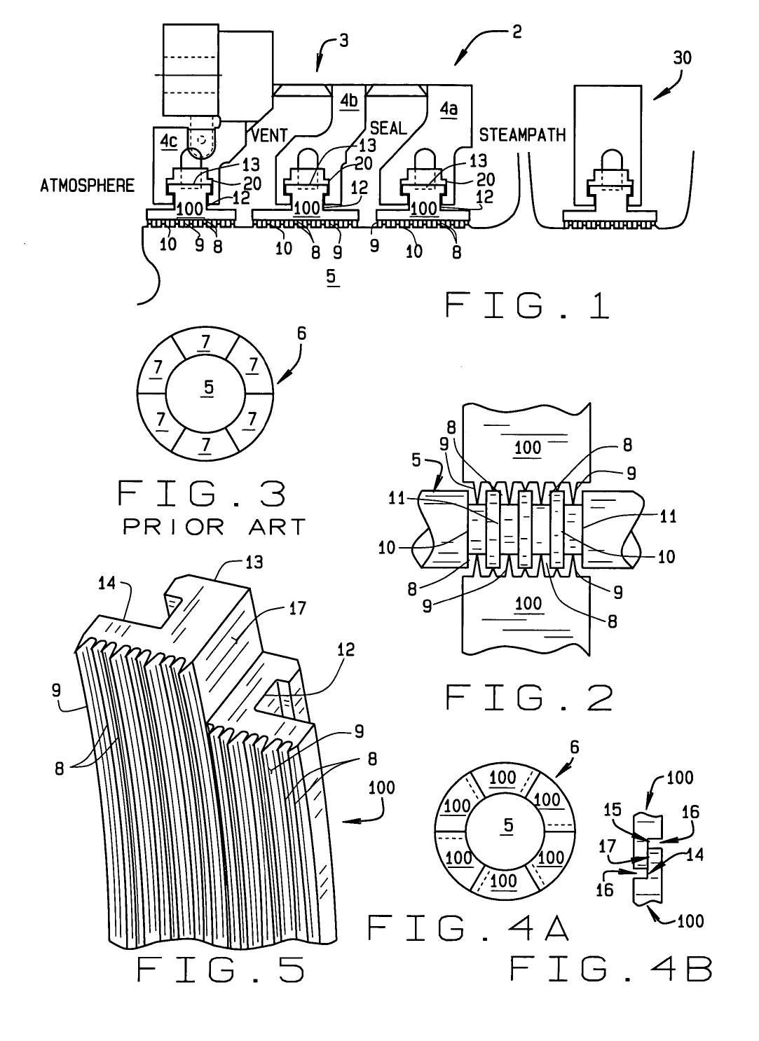

Referring to the drawings, a steam turbine 1 is a multi-stage turbine having a plurality of stages 30, a representative one of which is shown in FIG. 1, and an end stage 2. A housing or ring assembly 3 includes a plurality of sections 4a-4c through which a turbine shaft 5 extends longitudinally of the turbine and through the casing. A separate packing ring 6 is assembled about shaft 5 and housed in each section 4a-4c. As shown in FIG. 3, each ring 6 is comprised of a plurality of interfacing ring segments 7. While six such segments are shown in FIG. 3, it will be understood that four-twelve segments are typically used to form ring 6.

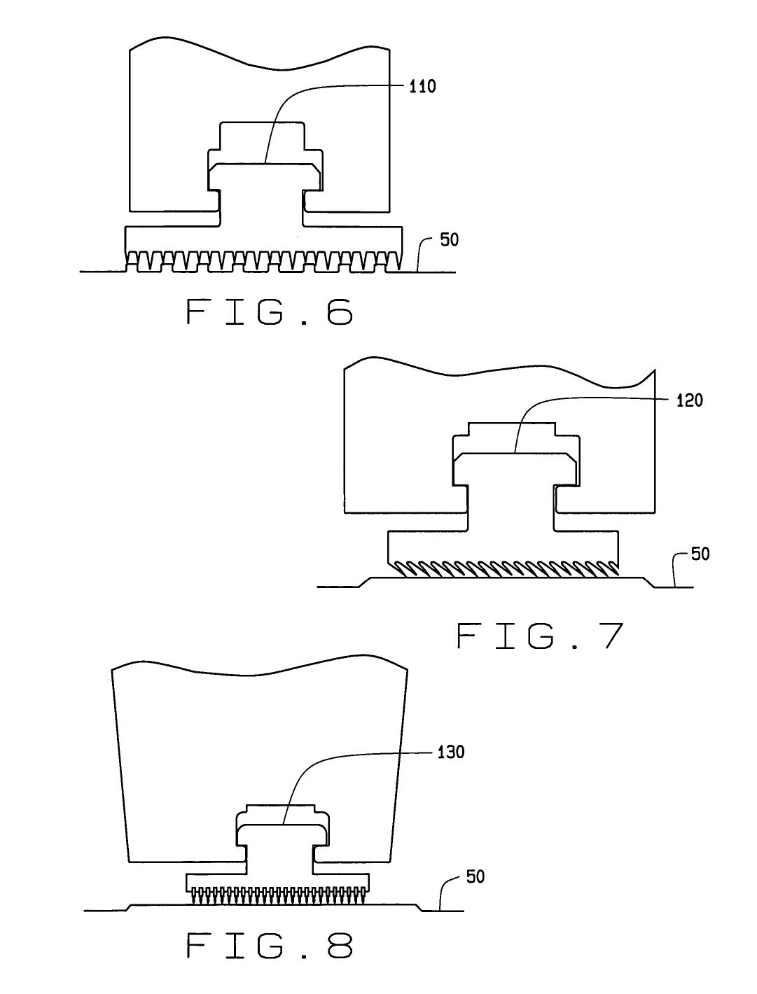

Referring to FIGS. 4 and 5, a ring segment of the present invention is indicated generally 100. Each ring segment 100 fits about shaft 5, as shown in FIG. 4, to form a packing seal about the shaft and restrict the working fluid from leaking from one turbine stage to the next, or from end stage 2 of the turbine to the atmosphere. Different ring segments can have different tooth arrangements. Thus, as shown in FIGS. 1, 2, and 5, a ring segment 100 has two sets of teeth 8 and 9 formed on its inner surface and interfitting with lands and grooves 10 and 11 formed on shaft 5. Referring to FIGS. 6-8, ring segments 110, 120, and 130, which are otherwise constructed as ring segment 100, are shown to have different tooth patterns, and the ring segments can be used with a shaft 5 having lands and grooves as shown in FIG. 6, or a smooth outer surface shaft 50 as shown in FIGS. 7 and 8. Regardless of the tooth pattern, the teeth create a labyrinth or convoluted path that prevents steam expanding through the seal formed by packing ring 6 and thereby leaking across the interface between turbine stages, or end stage 2 and the atmosphere.

Next, a central protrusion 12 extends radially outwardly from an outer surface on the opposite side of segment 100 from the teeth, and a cap 13 extends across the outer end of the protrusion. The protrusion and cap together form a T-shaped band (when viewed from the end of a packing ring segment). When all the packing ring segments are fitted together, the T-shaped protrusions form a raised band completely encircling the outside of the ring and fitting within an annular groove 20 formed in each casing section 4a-4c. The band affects a circumferential seal about shaft 5 so, again, the leakage of working fluid is effectively minimized between turbine stages or an end stage of the turbine and the atmosphere.

As shown in FIG. 5, and in accordance with the present invention, each ring segment 100 has a notch or step 14 formed at one end of the segment, and a correspondingly sized, complimentary notch or step 15 formed at its other end, on the opposite side of the segment. Thus, in FIG. 5, step 14 is formed at the upper, inner end of segment 100, and step 15 is formed at the lower, outer end of the segment.

The steps 14, 15 are formed on opposite sides of the segment so when a packing ring 6 is assembled, a butt gap 16 (see FIG. 4B) formed between adjacent ring segments is larger than otherwise required. At the same time, a steam seal is formed by abutting sealing faces 17 of adjacent segments 100. Having an oversize butt gap allows the adjacent segments to readily interface with each other without additional work being required to insure a proper fit when the segments thermally expand during operation of turbine 1.

Ring assembly 6 provides an effective longitudinal seal at the interface between turbine stages, or the end stage and the atmosphere, without additional time and expense being incurred. As the reasons previously noted, the ring segments 100 are especially advantageous for turbines used in nuclear facilities. When packing rings 6 are being assembled, the ring segments of the present invention allow the rings to be rapidly assembled without the segments having to be reworked thereby eliminating effort required and incremental outage time

For the utility, whether it uses conventional or nuclear power, use of ring segments 100 to assemble a packing ring 6 decreases repair costs, enhances employee safety by reducing their exposure to a hostile environment, and enables a turbine to be brought back on-line more quickly than was previously possible using prior art ring segments 7.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A packing ring segment (100) for use in a packing ring (6) to minimize leakage of a working fluid between a first element and a second element comprising:
an arcuate shaped ring segment (100) which interfits with similarly formed segments to form an annular seal at an interface between the elements, a butt gap (16) being formed between adjacent segments;
each ring segment having a step (14, 15) formed at each end thereof for interfacing the segment with an adjacent segment's extended butt gap, thereby eliminating rework of segments to form a predetermined butt gap when the packing ring is assembled, and the packing ring, when assembled, creating an effective seal against fluid leakage between the elements.

2. The ring segment of claim 1 in which a step is formed on an opposite side of the ring segment at the respective ends thereof.

3. The ring segment of claim 2 in which the steps are complimentary steps.

4. The ring segment of claim 2 further including a plurality of teeth (8, 9) formed on an inner surface of the segment and extending radially outwardly from the surface.

5. The ring segment of claim 2 in which the teeth extend the length of the segment, parallel to each other and to a longitudinal centerline of the segment.

6. The ring segment of claim 3 in which a shaft (5) extends between the elements adjacent the teeth and the teeth and shaft form a labyrinth which prevents the working fluid from expanding across the seal and leaking between the first and second elements.

7. The ring segment of claim 2 further including a central protrusion (12) extending radially outwardly from an outer surface of the segment so, when the segments are fitted together to complete the packing ring, a circumferential band is formed encircling the outside of the ring assembly and providing a circumferential seal thereabout.

8. The ring segment of claim 7 further including a cap (13) is extending across the outer end of the protrusion so to form a T-shaped band.

9. The ring segment of claim 8 further including a casing (4a-4c) having an annular groove (20) in which the band fits when the packing ring is assembled.

10. A packing ring segment (100) for use in assembling a packing ring (6) in a turbine (1) to minimize leakage of a working fluid from one stage of the turbine to another stage thereof, or from an end stage (2) of the turbine to the atmosphere:
an arcuate shaped ring segment (100) which interfits with similarly formed segments to form an annular seal about a turbine shaft (5) at an interface between stages of the turbine or between the end stage and the atmosphere, a butt gap (16) being formed between adjacent segments;
each ring segment having a step (14, 15) formed at each end thereof for interfacing the segment with an adjacent segment without regard to the size of the resulting butt gap, thereby eliminating rework of segments to form a predetermined butt gap when the packing ring is assembled, and the packing ring, when assembled, creating an effective seal against fluid leakage.

11. The ring segment of claim 10 in which a step is formed on an opposite side of the ring segment at the respective ends thereof.

12. The ring segment of claim 11 in which the steps are complimentary steps.

13. The ring segment of claim 10 further including a plurality of teeth (8, 9) formed on an inner surface of the segment and extending radially outwardly from the surface.

14. The ring segment of claim 13 in which the teeth extend the length of the segment, parallel to each other and to a longitudinal centerline of the segment.

15. The ring segment of claim 13 in which a shaft (5) extends between the elements adjacent the teeth and the teeth and shaft form a labyrinth which prevents the working fluid from expanding across the seal and leaking between the first and second elements.

16. The ring segment of claim 11 further including a central protrusion (12) extending radially outwardly from an outer surface of the segment so, when the segments are fitted together to complete the packing ring, a circumferential band is formed encircling the outside of the ring assembly and providing a circumferential seal thereabout.

17. The ring segment of claim 16 further including a cap (13) is extending across the outer end of the protrusion so to form a T-shaped band.

18. The ring segment of claim 17 in which the turbine has a casing (4a-4c) surrounding the shaft, and the casing includes an annular groove (20) in which the band fits when the packing ring is assembled.
